(19) United States
(12) Patent Application Publication
(10) Pub. No.: US 2004/0034836 A1
(43) Pub. Date: Feb. 19, 2004

(54) Information partitioning apparatus, information partitioning method, information partitioning program, and recording medium on which information partitioning program has been recorded

(75) Inventor: Atsushi Ikeno, Kyoto (JP)

Correspondence Address: VENABLE, BAETJER, HOWARD AND CIVILETTI, LLP, P.O. BOX 34385, WASHINGTON, DC, 20043-9998, US

(73) Assignee: OKI ELECTRIC INDUSTRY CO., LTD., Tokyo (JP)

(21) Appl. No.: 10/603,835

(22) Filed: Jun. 26, 2003

(30) Foreign Application Priority Data
Jun. 27, 2002 (JP) 2002-187698
Jan. 9, 2003 (JP) 2003-002981

(51) Int. Cl. G06F 17/00

(52) U.S. Cl. 715/530

(57) ABSTRACT

An information partitioning apparatus according to the present invention applies a division pattern defining a predetermined character string which can be represented in a division line to an inputted electronic document to divide the electronic document into a plurality of partial documents. Thereafter, the information partitioning apparatus applies labeling patterns provided with classification information pieces for defining a predetermined character string which can specify classification to the respective divided partial documents to provide the partial documents with the classification information pieces. Therefore, respective information pieces in an electronic document which does not have clear structural information, such as a mail magazine or the like, can be divided properly.

### BACKGROUND OF THE INVENTION

The present invention relates to an information partitioning apparatus, an information partitioning method, an information partitioning program and a recording medium on which an information partitioning program has been recorded, and in particular to a technique for partitioning and classifying information contained in an electronic document in which a plurality of information pieces have been described.

### DESCRIPTION OF THE RELATED ART

In recent years, spreading of such a network technique as Internet or the like allows access to a large number of domestic and foreign electronic documents so that necessity for automation of intellectual work such as classification of a large volume of electronic document information or the like is increased.

As one of acquiring methods for an electronic document which have been developed nowadays, there is a mail-magazine (one similar to a magazine/newspaper through a mail). This is for delivering one electronic mail including a plurality of information pieces in a collective manner to subscribers.

Such an electronic mail can be recognized as an electronic document on which a plurality of information pieces have been described, and it is necessary to partition the respective information pieces on the electronic document properly in order to classify the information pieces.

In Japanese Patent Laid-open Publication No. 2000-285140A, an example of an apparatus used as assistance for information classification by providing means for dividing document data pieces on the basis of structural information of document data (tag of HTML, font information of a character or the like) or providing means for dividing document data pieces on the basis of a document element (for example, a word), information following a document element (for example, a part of speech) has been disclosed.

However, in the apparatus described in the above-described publication, there is such a problem that the apparatus can not be applied to an electronic document which does not have a clear structural information, such as a mail magazine.

Further, even if information for dividing one mail magazine properly is specified, in case that a plurality of mail magazines have been received, a possibility that respective mail magazines requires different classifications of division information (division patterns) is high. Therefore, there occurs such a problem that selection of a proper division pattern and division are impossible due to the classification of a mail magazine.

Furthermore, according to increase of the number of mail magazines to be received, the number of kinds of division pattern also increases, so that there is such a problem that it is troublesome to designate the kinds of division pattern to respective mail magazines manually.

For this reason, it is desired to provide an information partitioning apparatus which can divide respective information pieces in an electronic document which does not have a clear structural information, such as a mail magazine or the like properly, or the like.

### SUMMARY OF THE INVENTION

According to a first aspect of the present invention, there is provided an information partitioning apparatus which partitions information in an inputted electronic document, comprising: (1) division pattern storing means for storing therein one or plural division patterns defining a predetermined character string which can be represented in a division line; and (2) document dividing means for collating the inputted electronic document with the division patterns stored in the division pattern storing means to divide the electronic document to plural partial documents.

According to a second aspect of the invention, there is provided an information partitioning method which partitions information in an inputted electronic document, comprising a document dividing step of collating the inputted electronic document with a division pattern defining a predetermined character string which can be represented in a division line to divide the electronic document to plural partial documents.

According to a third aspect of the invention, there is provided an information partitioning program wherein the step of the information partitioning method of the above second aspect is described with a code which can be executed by a computer.

According to a fourth aspect of the invention, there is provided a recording medium in which the information partitioning program of the third aspect has been recorded.

### BRIEF DESCRIPTION OF THE DRAWINGS

FIG. 1 is a block diagram showing a functional configuration of an information partitioning apparatus of a first embodiment;

FIG. 2 is an explanatory table showing a discriminating pattern data example of the first embodiment;

FIG. 3 is an explanatory table showing a dividing pattern data example of the first embodiment;

FIG. 4 is an explanatory table showing a labeling pattern data example of the first embodiment;

FIG. 5 is an explanatory diagram showing an inputted document example which is applied for explaining operation of the first embodiment;

FIG. 6 is an explanatory diagram showing data after a document division processing to the inputted document shown in FIG. 5;

FIG. 7 is a block diagram showing a functional configuration of an information partitioning apparatus of a second embodiment;

FIG. 8 is a flowchart showing operation of a division pattern producing section of the second embodiment; and

FIG. 9 is an explanatory table for grouping inputted characters at a time of division pattern production of the second embodiment.

### DETAILED DESCRIPTION OF THE PREFERRED EMBODIMENTS

### (A) First Embodiment

A first embodiment of an information partitioning apparatus, an information partitioning method and an information partitioning program, and a recording medium on which an information partitioning program has been recorded according to the present invention will be explained below in details with reference to the drawings.

(A-1) Configuration of a First Embodiment

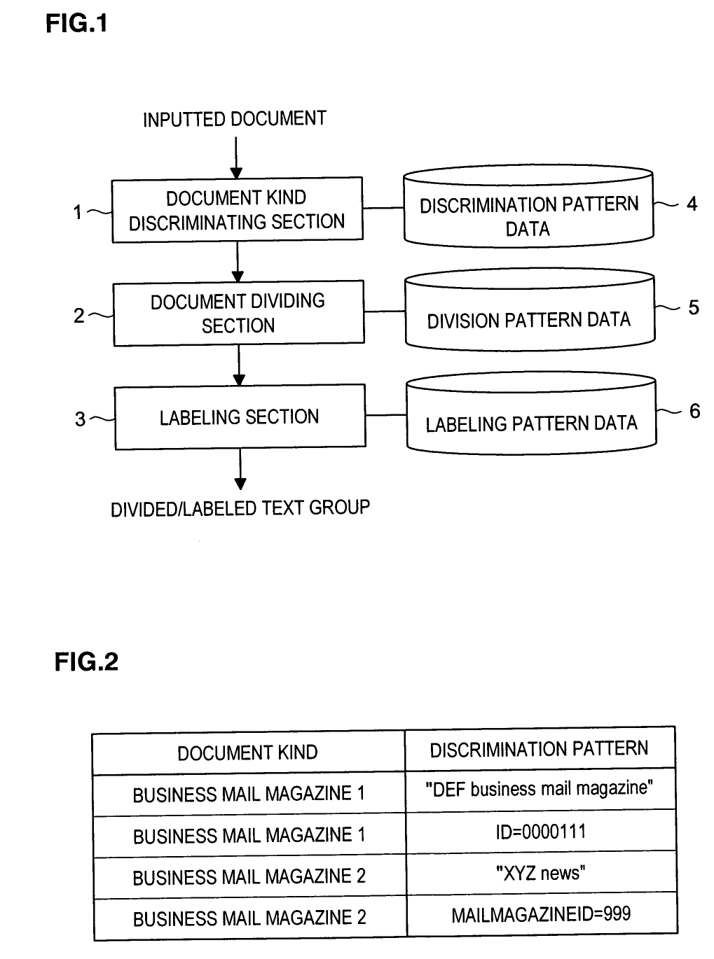

FIG. 1 is a block diagram showing a functional configuration of an information partitioning apparatus of a first embodiment. For example, the information partitioning apparatus of the first embodiment is realized by installing an information partitioning program which has been recorded in a recording medium such as a CD-ROM, a floppy (registered trademark) disc, or the like to an information processing apparatus such as a personal computer having a communication function or the like, but it can be functionally represented in FIG. 1.

In FIG. 1, the information partitioning apparatus of the first embodiment is provided with a document kind discriminating section 1, a document dividing section 2, a labeling section 3, a discrimination pattern data storing section 4, a division pattern data storing section 5 and a labeling pattern data storing section 6.

The document kind discriminating section 1 is for discriminating the kind of an inputted electronic document (which is called “a document” in some cases) in order to reference to discrimination pattern data in the discrimination pattern data storing section 4 to determine a division pattern and a labeling pattern to be applied.

Incidentally, in the first embodiment, an object to be inputted is one electronic document (for example, a mail magazine for news) in which a plurality of quite different information pieces have been included. Furthermore, an object to be inputted is an electronic document which does not have structure information but where punctuation for contents are described explicitly using surface information such as a symbol such that a person can recognize the contents.

The document dividing section 2 is for dividing an inputted electronic document by applying division pattern data which has been stored in the division pattern data storing section 5 and which has been determined according to the discrimination result of the document kind discriminating section 1 (that is, the classification of the electronic document).

The labeling section 3 is for applying or using the labeling pattern data which has been stored in the labeling pattern data storing section 6 and has been determined on the basis of the discrimination result of the document kind discriminating section 1 (that is, the classification of the electronic document) to give classification information to respective portions of the input documents divided by the document dividing section 2 (perform labeling on the respective portions).

The discrimination pattern data stored in the discrimination pattern data storing section 4 is a collection of data pieces for the document classification discriminating section 1 to discriminate the classification of an electronic document. As a discrimination pattern of the simplest form, a specific character string (for example, in case of a mail magazine, the title or the ID number in the mail magazine) can be employed.

FIG. 2 shows one example of the discrimination pattern data. Each record includes a document classification and a discrimination pattern which is applied to the document classification. As shown in FIG. 2, a plurality of discrimination pattern data pieces can exist for one classification of an electronic document.

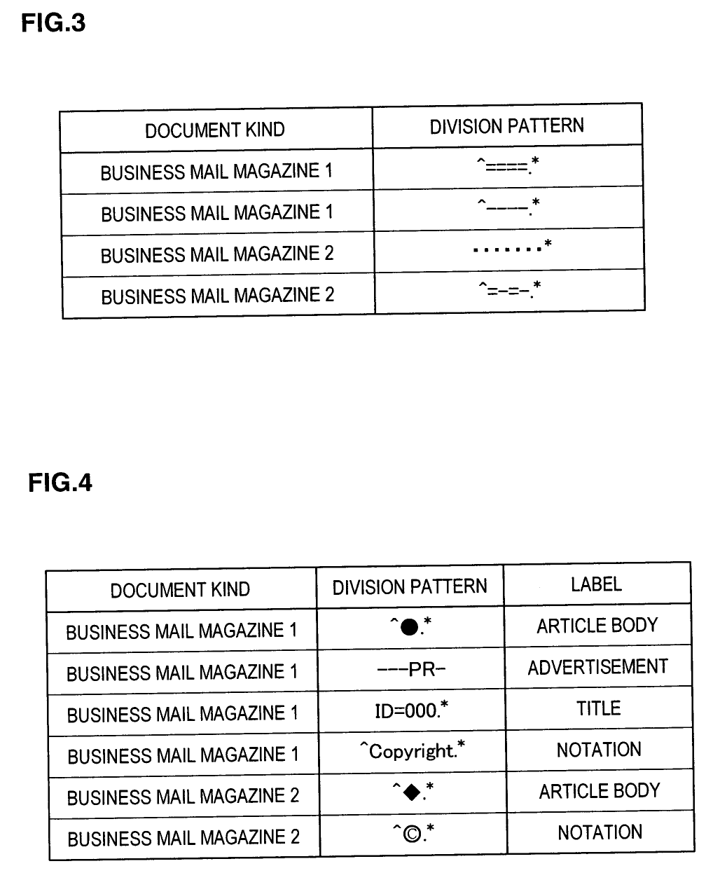

The division pattern data stored in the division pattern data storing section 5 is data for the document dividing section 2 to divide an electronic document, and it is data for defining a predetermined character string which can be represented in a division line. The division pattern data is data where document kind and division pattern are associated with each other, for example, as shown in FIG. 3. Since the division pattern in FIG. 3 is described with a normal expression, a symbol “Λ” in the pattern means “line head”, “ .” means “an arbitrary character”, and “*” means “a character just before “*” appearing at least 0 time”. For example, “Λ====, *” in FIG. 3 shows such a pattern that [after half size of character “=” symbol appears four times from a line head, a character appears at least 0 time]. As shown in FIG. 3, a plurality of division pattern data pieces may exist for a classification of an electronic document. Furthermore, a division pattern data piece which can be applied regardless of the classification of an electronic document may be provided.

The labeling pattern data stored in the labeling pattern data storing section 6 is data for the labeling section 3 to give classification information to respective portions (respective information pieces) of the electronic document divided by the document dividing section 2 (performing labeling), and it is data for defining a predetermined character string which can specify the classification. The labeling pattern data is a collection of data pieces where document classifications, labeling patterns and label names are associated with one another, for example, as shown in FIG. 4. The labeling patterns shown in FIG. 4 are described with normal expressions. As shown in FIG. 4, a plurality of labeling pattern data pieces ordinarily exist for an electronic document of a certain classification. Further, a labeling pattern data piece which is applicable regardless of the classification of an electronic document may be provided.

(A-2) Operation of the First Embodiment

Operation of the information partitioning apparatus of the first embodiment (the information partitioning method) will be explained below for each of operations of respective constituent elements 1 to 3.

Operation of the document classification discriminating section 1 will first be explained.

The document kind discriminating section 1 discriminates a document kind by using each pattern data piece stored in the discrimination pattern data storing section 4 to conduct a pattern matching in an inputted electronic document. Incidentally, the inputted document can be fetched via a network, or it may be fetched from a recording medium. Thus, an arbitrary inputting method can be adopted.

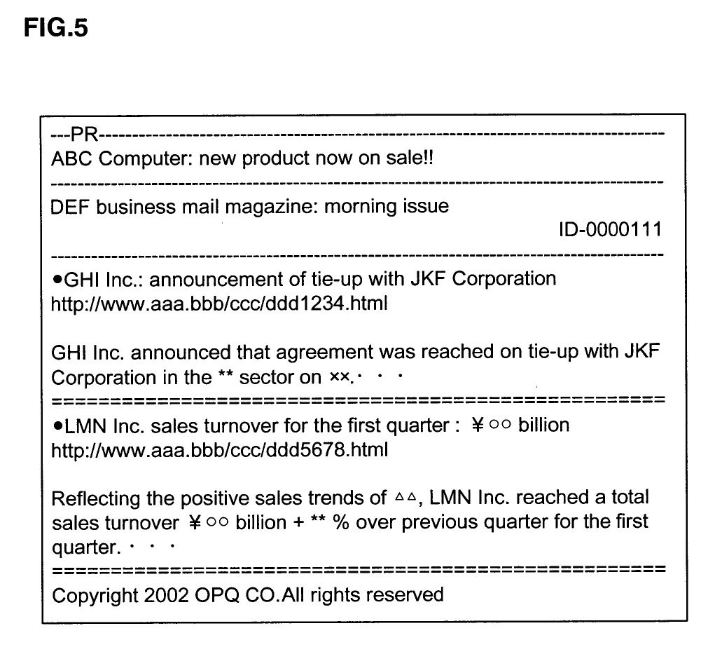

Here, in case that the inputted document is an electronic document such as shown in FIG. 5, the electronic document in FIG. 5 is discriminated as the classification “business mail magazine 1”, since the first or second pattern data piece in FIG. 2 exist.

Incidentally, in case that a plurality of pattern data pieces are matched and a conflict exists in the discrimination result, such a function for making determination on the basis of the decision of majority (the number of matches is larger) or notifying the fact that there is a conflict in the result to a user may be provided.

Next, operation of the document dividing section 2 will be explained.

As described, the document dividing section 2 uses respective division pattern data pieces of the discriminated document kind which have been stored in the division pattern data storing section 5 to divide the inputted electronic document into a plurality of partial documents (information pieces).

Since the electronic document shown in FIG. 5 has been discriminated as the classification “business mail magazine 1” by the document kind discriminating section 1, the first and second division patterns in FIG. 3 are applicable thereto. That is, since portions that (1) a predetermined or more number of “-” (hyphen expressed by half size of character) continues from a leading character and that (2) a predetermined or more number of “=” (equal sign expressed by half size of character) continues from the leading character forms division patterns, the inputted document are divided to partial documents (information pieces) at these positions (lines).

The respective partial documents obtained by the division are stored in the storage device storing all data pieces separately from the original data. Incidentally, the storing section for the respective partial documents is shown in FIG. 1 so as to be included in the document dividing section 2.

Further, a method (1) where the division pattern itself used for the division is not included in the partial documents obtained by the division (the division pattern is deleted), a method (2) where the division pattern is included in any one of the partial documents positioned before or after the division position, or a method (3) where the division pattern is included in both of the partial documents positioned before and after the division position (the division pattern is reproduced) is applied.

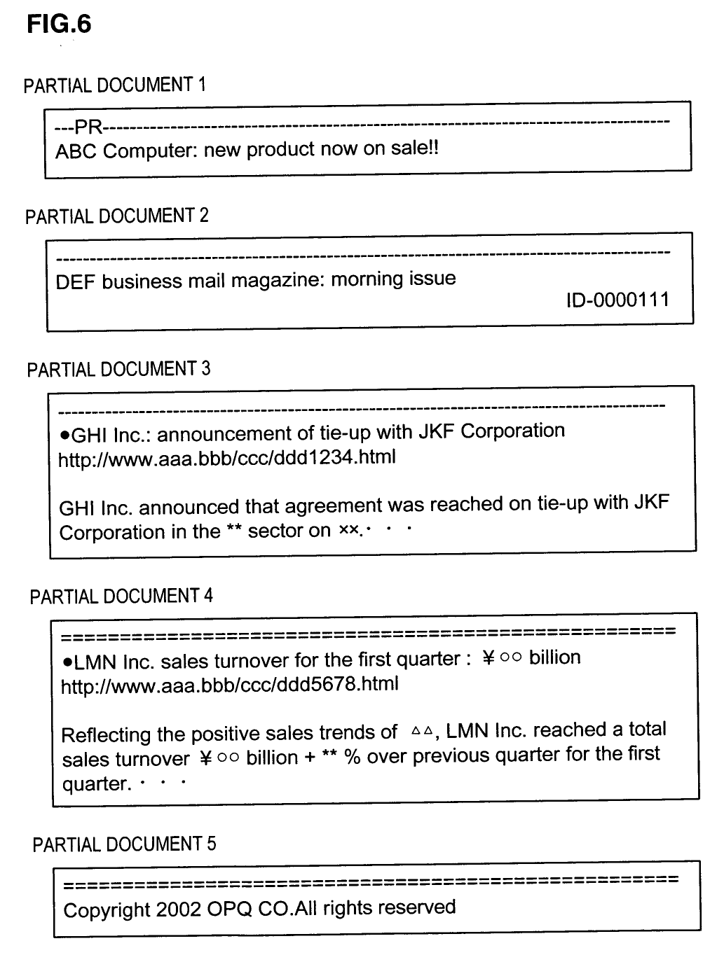

In case that the method (2) is applied regarding handling the division pattern, the inputted document in FIG. 5 is divided into five partial documents such as shown in FIG. 6.

Next, operation of the labeling section 3 will be explained.

As described above, the labeling section 3 uses respective labeling pattern data pieces of the discriminated document kind which have been stored in the labeling pattern data storing section 6 to perform labeling on a partial document pattern-matched.

Since the electronic document in FIG. 5 (FIG. 6) has been discriminated as the classification “business mail magazine 1” by the document kind discriminating section 1, the first to fourth labeling pattern data pieces in FIG. 4 is utilized, so that “advertisement” is labeled on a partial document 1, “Title” is labeled on a partial document 2, “Article body” is labeled on partial documents 3 and 4, and “Notation” is labeled on a partial document 5.

For example, since such a pattern as “- - - PR -” exists in the partial document 1, the second line in FIG. 4 is applied to be labeled as “advertisement”. These label information pieces are held in a manner paired with respective partial documents.

The information of the partial document having label information is outputted in a displaying manner, is outputted in a printing manner, or is transmitted to another device according to operation of a user or the like. At this time, for example, a user can designate only the article body to output the same. Further, processing may further be performed on the information of the partial document having label information. For example, an abstract preparing processing can be applied to the article body.

(A-3) Advantage (Effect) of the First Embodiment

As described above, according to the first embodiment, not only an electronic document having a clear structure, such as described with XML, HTML, SGML or the like, but also an electronic document other than that can be divided and classified by only preparing division pattern data and labeling pattern data based upon simple patterns.

In addition, since the document kind discriminating section is provided, a plurality of division patterns are managed and various kinds of electronic documents can be divided and classified as an object to be classified.

### (B) Second Embodiment

Next, a second embodiment of an information partitioning apparatus, an information partitioning method and an information partitioning program, and a recording medium on which an information partitioning program has been recorded according to the present invention has been recorded will be explaining in details with reference to the drawings.

(B-1) Configuration of the Second Embodiment

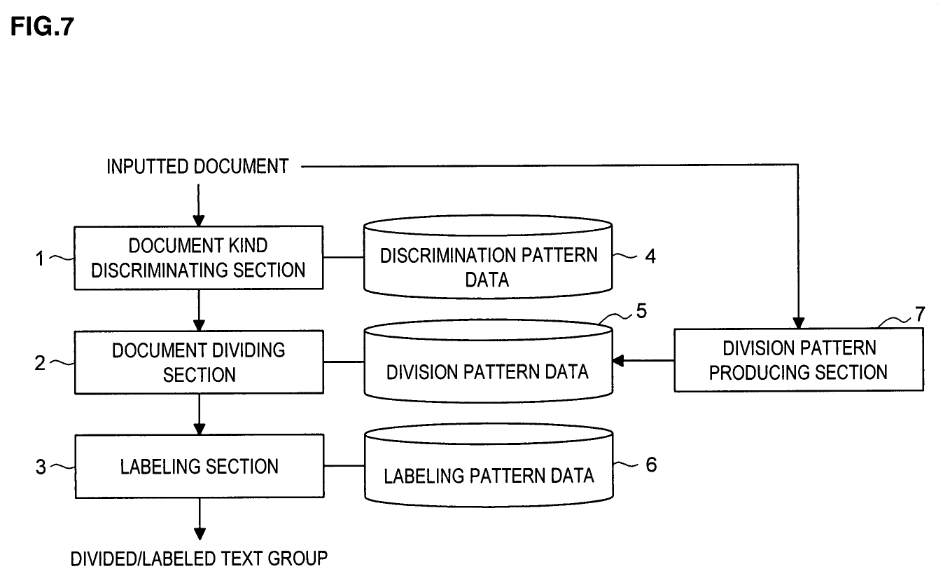

FIG. 7 is a block diagram showing a functional configuration of the information partitioning apparatus of the second embodiment, and portions identical or corresponding to those in FIG. 1 showing the first embodiment are attached with same reference numerals.

The information partitioning apparatus of the second embodiment has a configuration where a division pattern producing section 7 is added to the configuration of the first embodiment.

The division pattern producing section 7 is for producing a division pattern on the basis of an inputted electronic document. A division pattern produced by the division pattern producing section 7 is associated with the document kind discriminated by the document kind discriminating portion 1 to be stored in the division pattern data storing section 5 as the division pattern data.

Since sections other than the division pattern producing section 7 have functions identical to those in the first embodiment, explanation thereof will be omitted.

(B-2) Operation of the Second Embodiment

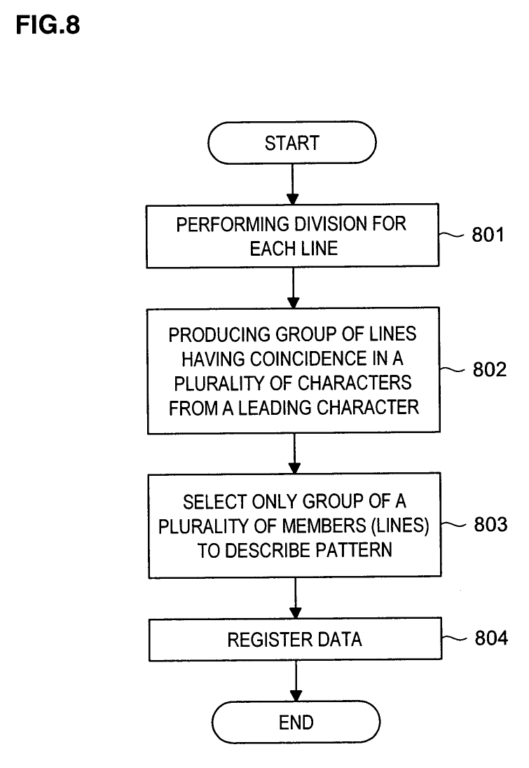

Since the operation of the second embodiment is different only in the division pattern producing section 7 from that of the first embodiment, only the operation of the division pattern producing section 7 will be explained below with reference to a flowchart in FIG. 8.

When a document is inputted, the division pattern producing section 7 divides the inputted document to respective lines (Step 801). Next, a group of lines where all characters positioned at a predetermined position when counted from a leading character (for example, the thirtieth characters) are the same is produced and the number of lines belonging to the group of lines is also counted (Step 802).

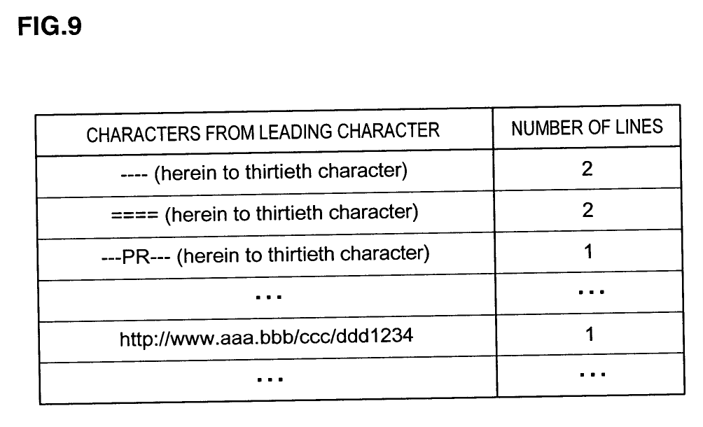

For example, in case that the above-described electronic document shown in FIG. 5 is an inputted document, a line group such as shown in FIG. 9 is produced at a stage after the processing in Step 802 has been completed.

Thereafter, the division pattern producing section 7 selects only a line group having a plurality of members (lines) (herein, the plurality indicates two) to perform a pattern description (Step 803). The simplest pattern description method is a character string itself, but an approach for rewriting the character string to a normal expression as needed can be used. If the division pattern producing section 7 can perform an output in a form which the document dividing section 2 can understand, an approach to be employed is not limited to a specific one.

Thereafter, the division pattern producing section 7 fetches data about the document kind from the document kind discriminating section 1 to complete division pattern data and register the same in the division pattern data storing section 5 (Step 804). Incidentally, such a configuration can be employed that a division pattern data which does not include data about the document kind is registered.

The number of characters used for discriminating line coincidence in the above-described Step 802 or the number of members (lines) used for discriminating whether the registration should be conducted in Step 803 may be set freely. Further, “a plurality of characters counted from a leading character” is described in Step 802, but it may be changed to “a plurality of characters from a final character”, it may be changed to“a plurality of characters from a leading character and a final character” or it may be changed to “a plurality of characters regardless of a leading character and a final character”. Moreover, such a form can be employed that these numbers can be set freely.

(B-3) Advantage of the Second Embodiment

According to the second embodiment, an advantage or effect similar to that of the first embodiment can be achieved, and such an advantage can further be achieved that the division pattern data is automatically produced and registered.

### (C) Other Embodiments

In each of the above-described embodiments, the case that, after division of an inputted document is performed, labeling to respective partial documents is performed has been disclosed, but division of an inputted document and labeling to respective partial documents obtained by the division may simultaneously be performed in this invention.

Further, such a configuration can be employed that division pattern data is used as a portion of the labeling pattern data. That is, the labeling pattern may include the same pattern as the division pattern.

In each of the above-described embodiments, the case that the inputted document is a horizontal writing document has been described, but such a configuration can be employed that a vertical writing document is allowed. In this case, a processing similar to that in each of the embodiments can be performed by utilizing a line pattern extending in a vertical direction.

In each of the above embodiments, also, the case that the document kind discriminating section automatically discriminates the kind of an inputted document has been described, but such a configuration can be employed that a user or the like inputs the kind of an inputted document. Further, such a configuration can be employed that all division patterns and labeling patterns are preliminarily registered regardless of document kind so that division to partial documents and labeling to the partial documents obtained by the division are performed without designating the kind of the inputted document. Furthermore, the apparatus can be configured as an information partitioning apparatus exclusive to an inputted document of a specified kind.

Moreover, the division pattern in each of the above embodiments is for defining that the line is a division line. However, such a division pattern (a searching division pattern) may be provided that, when discrimination has been made that, within a predetermined line from a line coincident with the division pattern (a searching division pattern), there is not a line coincident with another division pattern, the line coincident with the division pattern (a searching division pattern) is defined as the division line.

As described above, according to the present invention, respective information pieces in an electronic document which does not have clear structural information, such as a mail magazine or the like, can be divided properly.

What is claim d is:

1. An information partitioning apparatus for partitioning information in an inputted electronic document, comprising: division pattern storing means for storing therein one or plural division patterns defining a predetermined character string which can be represented in a division line; and document dividing means for applying the one or more plural division patterns stored in the division pattern storing means to the inputted electronic document to divide the electronic document to plural partial documents.

2. An information partitioning apparatus according to claim 1, wherein the division pattern storing means stores plural division patterns for an electronic document of one kind.

3. An information partitioning apparatus according to claim 1, wherein the division pattern storing means stores a division pattern which can be applied regardless of the kind of an electronic document.

4. An information partitioning apparatus according to claim 1, wherein the division pattern storing means stores such a division pattern (a searching division pattern) that, when discrimination has been made that, within a predetermined line from a line coincident with the division pattern (a searching division pattern), there is not a line coincident with another division pattern, a line coincident with the division pattern (a searching division pattern) is defined as the division line.

5. An information partitioning apparatus according to claim 1, further comprising: labeling pattern storing means for storing therein plural labeling patterns provided with classification information pieces for defining a predetermined character string which can specify classification; and
labeling means for applying the labeling patterns stored in the labeling pattern storing means to the respective partial documents obtained by the division conducted by the document dividing means, respectively, to provide the classification information pieces.

6. An information partitioning apparatus according to claim 5, wherein the labeling pattern storing means stores plural labeling patterns for an electronic document of one kind.

7. An information partitioning apparatus according to claim 5, wherein the labeling pattern storing means stores a labeling pattern which can be applied regardless of the kind of an electronic document.

8. An information partitioning apparatus according to claim 5, wherein the labeling pattern includes the same pattern as the division pattern.

9. An information partitioning apparatus according to claim 1, further comprising: discrimination pattern storing means for storing therein discrimination patterns for discriminating the kind of the electronic document inputted; and
document kind discriminating means for referencing to the discrimination patterns stored in the discrimination pattern storing means to discriminate the kind of the inputted electronic document.

10. An information partitioning apparatus according to claim 1, further comprising division pattern producing means for recognizing existence of plural lines including similar character strings in similar positions in the electronic document inputted to produce the division pattern and register the same in the division pattern storing means.

11. An information partitioning apparatus according to claim 1, wherein the electronic document is a mail magazine.

12. An information partitioning method for partitioning information in an inputted electronic document, comprising:
a document dividing step of applying one or plural division patterns defining a predetermined character string which can be expressed in a division line to the electronic document inputted to divide the electronic document to plural partial documents.

13. An information partitioning method according to claim 12, wherein, when discrimination has been made that, within a predetermined line from a line coincident with a division pattern (a searching division pattern), there is not a line coincident with another division pattern, a line coincident with the division pattern (a searching division pattern) is defined as the division line.

14. An information partitioning method according to claim 12, further comprising a labeling step of applying labeling patterns provided with classification information pieces for defining a predetermined character string which can specify classification to the respective partial documents obtained by the division conducted in the document dividing step to provide the classification information pieces.

15. An information partitioning method according to claim 14, further comprising a document kind discriminating step of discriminating the kind of the electronic document inputted, wherein the document dividing step performs dividing to partial documents using the discriminated division patterns for document kind, and
the labeling step provides the classification information pieces using the discriminated labeling patterns for the document kind.

16. An information partitioning method according to claim 12, further comprising a division pattern producing step of recognizing existence plural lines including similar character strings at similar positions in the electronic document inputted to produce the division pattern and register the same.

17. An information partitioning method according to claim 12, wherein the electronic document is a mail magazine.

18. An information partitioning program wherein the information partitioning method according to claim 12 has been described with a code which can be executed by a computer.

19. A recording medium in which the information partitioning program according to claim 18 has been recorded.
